(19) United States
(12) Patent Application Publication
(10) Pub. No.: US 2018/0373082 A1
(43) Pub. Date: Dec. 27, 2018

(54) OPTICAL DEVICE, AND WINDOW WITH LIGHT DISTRIBUTION FUNCTION

(71) Applicant: PANASONIC INTELLECTUAL PROPERTY MANAGEMENT CO., LTD., Osaka (JP)

(72) Inventors: Kazuki KITAMURA, Osaka (JP); Norihiro ITO, Osaka (JP); Hirofumi KUBOTA, Osaka (JP); Masuyuki OTA, Osaka (JP)

(73) Assignee: PANASONIC INTELLECTUAL PROPERTY MANAGEMENT CO., LTD., Osaka (JP)

(21) Appl. No.: 16/064,335

(22) PCT Filed: Dec. 1, 2016
(86) PCT No.: PCT/JP2016/005036

§ 371 Date: Jun. 20, 2018

(30) Foreign Application Priority Data
Jan. 12, 2016 (JP) 2016-003681

(51) Int. Cl. G02F 1/1343; G02F 1/1335; G02F 1/01

(52) U.S. Cl. CPC G02F 1/13439; G02F 1/0105; G02F 1/133553; G02F 1/133536

(57) ABSTRACT

An optical device includes a first substrate which is light-transmissive, a second substrate which is light-transmissive and opposes the first substrate, a light distribution layer which is interposed between the first substrate and the second substrate and distributes incident light, and an optical element which is disposed on one of a surface of the second substrate on a side opposite to a side facing the first substrate and a surface of the first substrate on a side opposite to a side facing the second substrate. The light distribution layer includes an optical medium containing a birefringent material and an uneven structure. The optical element has an optical property of reducing an amount of at least one of first polarized light and second polarized light that differ in a polarization direction.

### TECHNICAL FIELD

The present invention relates to an optical device and a window that has the optical device and a light distribution function.

### BACKGROUND ART

An optical device has been proposed which can change a traveling direction of outside light, such as sunlight entering from outside a room, and introduce the outside light into the room.

For example, Patent Literature 1 (PTL 1) discloses a lighting film that is affixed to a window to change a traveling direction of incident sunlight and introduce the sunlight into a room. The lighting film disclosed in PTL 1 includes a first base material, a plurality of lighting portions, a void, a first adhesion layer, a second base material, a second adhesion layer, and a light scattering layer. With this configuration, light entering the lighting portions is totally reflected off bottom surfaces of the lighting portions to travel obliquely upward and scattered by the light scattering layer. As a result, glare-reduced light illuminates, for example, a ceiling surface of the room.

### CITATION LIST

### Patent Literature

PTL 1: WO2015/056736

### SUMMARY OF THE INVENTION

### Technical Problem

A conventional optical device can deflect outside light, such as sunlight, to illuminate a ceiling surface of a room with this outside light, and thereby enhance indoor illuminance. Thus, an indoor lighting fixture can be turned off, and an optical output of the indoor lighting fixture can be reduced. This results in electrical power saving.

However, when the ceiling surface is illuminated with the outside light using the conventional optical device, or more specifically, when the light distribution is controlled to deflect the outside light using the conventional optical device, an outside view cannot be seen from inside the room. In particular, the optical device disclosed in PTL 1 employs reflection on an uneven interface between the void, which is an air layer, and the plurality of lighting portions formed from resin. Moreover, the light scattering layer causes light scattering all the time, making the window cloudy. For this reason, although the room can be brightened up, the outside view cannot be seen from inside the room. More specifically, a primary function of a window that the outside view can be seen is lost.

With this being the situation, an optical device has been studied which includes, instead of an air layer, a layer filled with a liquid crystal as a birefringent material and an uneven layer that contacts this layer. The birefringent material has a birefringent property (i.e., two refractive indexes). Thus, when one of the refractive indexes remains in agreement with a refractive index of the uneven layer, p-polarized light becomes transparent. On the other hand, since the other refractive index is different from the refractive index of the uneven layer, s-polarized light is distributed toward the ceiling surface.

In this case, the p-polarized light included in the reflected light from the outside view passes through the optical device and enters eyes of a person inside the room. Thus, even when the optical device is used, the outside view can be seen from inside the room without a loss of the primary function of a window that the outside view can be seen.

When sunlight is distributed and introduced into the room using the optical device as described above, s-polarized sunlight can be distributed toward the ceiling surface. However, p-polarized sunlight cannot be distributed. More specifically, p-polarized sunlight passes through the optical device and travels in a straight line toward a floor surface. Thus, a person by the window inside the room may be dazzled by bright sunlight.

The conventional optical device can distribute the incident light as described above. However, since the incident light includes a plurality of polarized light beams having respective different polarization directions, any one of these polarized light beams may travel toward an unintended area. For example, the incident light may pass straight through the optical device without being distributed and illuminate an unintended area.

The present invention is conceived in view of the stated problems, and has an object to provide the following: an optical device which performs light distribution control as desired on incident light including first polarized light and second polarized light that differ in the polarization direction and which causes the light to illuminate a predetermined area; and a window with a light distribution function.

### Solution to Problem

To achieve the aforementioned object, an optical device according to an aspect of the present invention includes: a first substrate which is light-transmissive; a second substrate which is light-transmissive and opposes the first substrate; a light distribution layer which is interposed between the first substrate and the second substrate and distributes incident light; and an optical element which is disposed on one of (i) a surface of the second substrate on a side opposite to a side facing the first substrate and (ii) a surface of the first substrate on a side opposite to a side facing the second substrate, wherein the light distribution layer includes (i) an optical medium containing a birefringent material and (ii) an uneven structure, and the optical element has an optical property of reducing an amount of at least one of first polarized light and second polarized light that differ in a polarization direction.

Moreover, a window with a light distribution function according to an aspect of the present invention includes: the optical device described above; and a window to which the optical device is affixed.

### Advantageous Effect of Invention

According to the present invention, light distribution control can be performed as desired on incident light including first polarized light and second polarized light that differ in the polarization direction, and the light can illuminate a predetermined area.

### BRIEF DESCRIPTION OF DRAWINGS

FIG. 1 is a cross-sectional view of an optical device according to Embodiment 1.

FIG. 2 is an enlarged cross-sectional view of the optical device according to Embodiment 1.

FIG. 3A is a diagram for explaining an optical action of the optical device in a transparent state, according to Embodiment 1.

FIG. 3B is a diagram for explaining an optical action of the optical device in a light distribution state, according to Embodiment 1.

FIG. 4A is a diagram showing an example of using an optical device according to a comparative example.

FIG. 4B is a diagram showing an example of using the optical device according to Embodiment 1.

FIG. 5 is an enlarged cross-sectional view of an optical device according to Variation 1 of Embodiment 1.

FIG. 6 is an enlarged cross-sectional view of an optical device according to Variation 2 of Embodiment 1.

FIG. 7 is an enlarged cross-sectional view of an optical device according to Variation 3 of Embodiment 1.

FIG. 8 is an enlarged cross-sectional view of an optical device according to Variation 4 of Embodiment 1.

FIG. 9 is an enlarged cross-sectional view of an optical device according to Embodiment 2.

FIG. 10 is an enlarged cross-sectional view of an optical device according to Embodiment 3.

### DESCRIPTION OF EXEMPLARY EMBODIMENTS

Hereinafter, embodiments according to the present invention are described. It should be noted that each of the embodiments below describes only a preferred specific example according to the present invention. Therefore, the numerical values, shapes, materials, structural elements, the arrangement and connection of the structural elements, and so forth described in the following embodiments are merely examples, and are not intended to limit the present invention. Thus, among the structural elements in the following embodiments, structural elements that are not recited in any one of the independent claims indicating top concepts according to the present disclosure are described as arbitrary structural elements.

Note that each of the accompanying drawings is only a schematic diagram and is not necessarily precise illustration. Thus, the reduction scales and the like in the drawings do not always agree with each other. Note also that, in all the drawings, the same reference numerals are given to the substantially same structural elements and redundant description thereof shall be omitted or simplified.

Moreover, X, Y, and Z axes mentioned in the present specification and accompanying drawings refer to three axes in three-dimensional Cartesian coordinate system. In the following embodiments, a Z axis direction refers to a vertical direction and a direction perpendicular to the Z axis (a direction parallel to an XY plane) refers to a horizontal direction. The X and Y axes are orthogonal to each other, and each of the X and Y axes is orthogonal to the Z axis. Here, a positive direction of the Z axis direction is a vertically downward direction. Moreover, a term “thickness direction” used in the present specification refers to a thickness direction of an optical device, and is a direction perpendicular to a main surface of a first substrate and to a main surface of a second substrate. Furthermore, a term “plan view” refers to a view seen from a direction perpendicular to the main surface of the first substrate and to the main surface of the second substrate.

### Embodiment 1

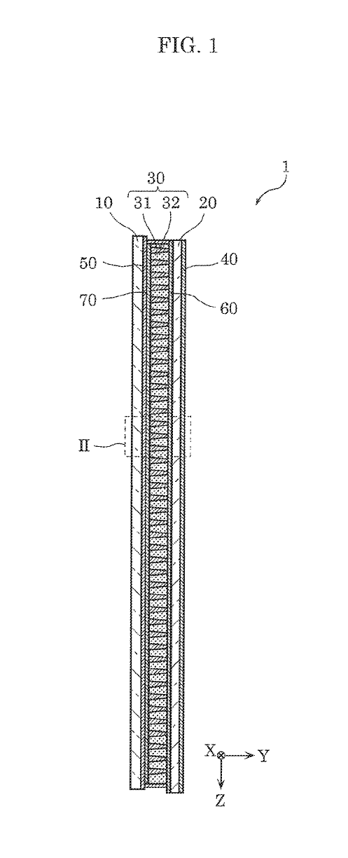

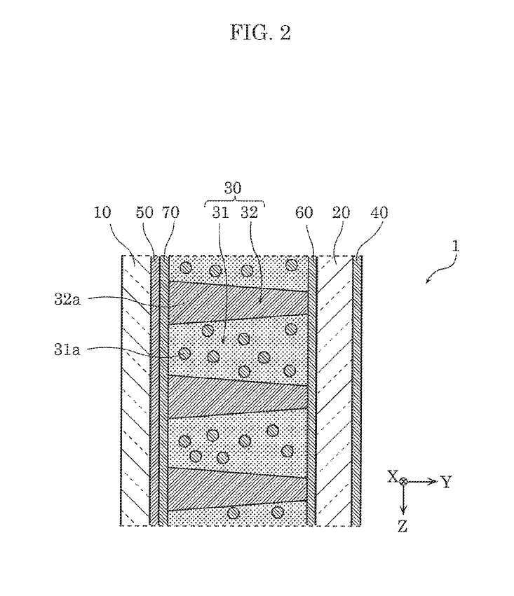

Firstly, a configuration of optical device 1 according to Embodiment 1 is described, with reference to FIG. 1 and FIG. 2. FIG. 1 is a cross-sectional view of optical device 1 according to Embodiment 1. FIG. 2 is an enlarged cross-sectional view of optical device 1, and is an enlarged cross-sectional view of region II surrounded by a dashed line in FIG. 1.

Optical device 1 is a light control device which controls light entering optical device 1. To be more specific, optical device 1 is a light distribution element which can change a traveling direction of light entering optical device 1 (or more specifically, perform light distribution) and then emit the light.

As shown in FIG. 1 and FIG. 2, optical device 1 includes first substrate 10, second substrate 20, light distribution layer 30, optical element 40, first electrode 50, and second electrode 60. Here, adhesion layer 70 is provided to allow first electrode 50 and uneven structure 32 of light distribution layer 30 to adhere tightly to each other, on a surface of first electrode 50 on the side closer to light distribution layer 30. However, adhesion layer 70 may not be provided.

Optical device 1 has a configuration in which first electrode 50, adhesion layer 70, light distribution layer 30, and second electrode 60 are arranged in this order in a thickness direction between a pair of first substrate 10 and second substrate 20.

The following describes structural members of optical device 1 in detail, with reference to FIG. 1 and FIG. 2.

### [First Substrate and Second Substrate]

Each of first substrate 10 and second substrate 20 shown in FIG. 1 and FIG. 2 is a light-transmissive substrate having translucency. For example, glass substrates or resin substrates may be used as first substrate 10 and second substrate 20. Examples of a material of a glass substrate include soda glass, alkali-free glass, and high refractive index glass. Examples of a material of a resin substrate include polyethylene terephthalate (PET), polyethylene naphthalate (PEN), polycarbonate (PC), acrylic (PMMA), and epoxy. A glass substrate has the advantage of a high optical transmittance and a low moisture permeability. On the other hand, a resin substrate has the advantage of being shatter-resistant when broken. First substrate 10 and second substrate 20 may be formed from the same material or from mutually different materials. However, it is preferable for first substrate 10 and second substrate 20 to be formed from the same material. A substrate used for each of first substrate 10 and second substrate 20 is not limited to a rigid substrate, and may be a flexible substrate having flexibility. In the present embodiment, each of first substrate 10 and second substrate 20 is a transparent resin substrate formed from a PET resin.

Second substrate 20 is an opposite substrate that opposes first substrate 10, and is disposed to be opposite to first substrate 10. First substrate 10 and second substrate 20 are bonded together by a sealing resin, such as an adhesive, that is formed in a shape of a picture frame around an outer perimeter for each of first substrate 10 and second substrate 20.

Here, each of first substrate 10 and second substrate 20 is in a shape of, for example, a quadrangle such as a square or a rectangle in a plan view. However, the shape of these substrates is not limited to this, and may be a circle or a polygon other than a quadrangle. Thus, any shape can be adopted.

### [Light Distribution Layer]

As shown in FIG. 1 and FIG. 2, light distribution layer 30 is interposed between first substrate 10 and second substrate 20. Light distribution layer 30 is light-transmissive and thereby allows incident light to pass through light distribution layer 30. Moreover, light distribution layer 30 distributes the incident light. To be more specific, light distribution layer 30 changes a traveling direction of the light that passes through light distribution layer 30.

Light distribution layer 30 includes the following: optical medium 31 containing a birefringent material; and uneven structure 32. The birefringent material of optical medium 31 is, for example, a liquid crystal containing liquid crystal molecule 31a that is birefringent. Examples of such a liquid crystal include a nematic liquid crystal or a cholesteric liquid crystal in which liquid crystal molecule 31a has a shape of a rod. Moreover, liquid crystal molecule 31a that is birefringent has an ordinary-light refractive index (no) of 1.5 and an extraordinary-light refractive index (ne) of 1.7, for example.

Uneven structure 32 includes a plurality of projections 32a in micro- or nano-order size. Each of the plurality of projections 32a has a height of, for example, 100 nm to 100 μm. However, a range of the height is not limited to this. Moreover, an interval between projections 32a adjacent to each other is, for example, 0 μm to 100 μm, and is not limited to this range.

Each of the plurality of projections 32a has an inclined surface that is inclined at a predetermined angle of inclination with respect to a thickness direction. The inclined surface of projection 32a is an interface between projection 32a and optical medium 31. Light incident on light distribution layer 30 is totally reflected off the inclined surface of projection 32a depending on a refractive index difference between projection 32a and optical medium 31, or passes through light distribution layer 30 without being reflected. In other words, the inclined surface of projection 32a functions as a light reflecting surface (a total reflecting surface) or a light transmitting surface.

The plurality of projections 32a are formed in stripes. To be more specific, the plurality of projections 32a are in the same shape and arranged at equally spaced intervals in a Z axis direction. Projection 32a is in a trapezoidal shape in cross section and has nearly a shape of an elongated quadratic prism that extends in an X axis direction.

Examples of a material of projection 32a include a resin material that is light-transmissive, such as an acrylic resin, an epoxy resin, or a silicon resin. Projection 32a can be formed by, for example, molding or nanoimprinting. As an example, projection 32a is an acrylic resin having a refractive index of 1.5.

In the present embodiment, optical medium 31 functions as a refractive-index adjustment layer in which the refractive index in a visible light region is adjustable with an application of an electric field. To be more specific, optical medium 31 includes a liquid crystal containing liquid crystal molecule 31a that has an electric field response function. On this account, the application of the electric field to light distribution layer 30 causes an orientation state of liquid crystal molecule 31a to change. This change in the orientation state thus changes the refractive index of optical medium 31.

Light distribution layer 30 is applied with an electric field through an application of a voltage to first electrode 50 and second electrode 60. Thus, by the control of the voltage to be applied to first electrode 50 and second electrode 60, the electric field to be applied to light distribution layer 30 changes. With this, the orientation state of liquid crystal molecule 31a changes and thus the refractive index of optical medium 31 changes. More specifically, the refractive index of optical medium 31 changes in response to the application of the voltage to first electrode 50 and second electrode 60. Depending on the change in the electric field, the refractive index of optical medium 31 changes into one of the following two: a refractive index that is the same as or near a refractive index of uneven structure 32 (projection 32a); and a refractive index that is significantly different from the refractive index of uneven structure 32 (projection 32a).

This change in the refractive index of optical medium 31 changes an optical action of optical device 1. To be more specific, the incident light is allowed to pass through optical device 1 with or without deflection. As described, optical device 1 is an active optical control device that can change the optical action by controlling refractive index matching between uneven structure 32 (projection 32a) and optical medium 31 using the electric field.

To be more specific, optical device 1 can switch between the following, in response to the change in the refractive index of optical medium 31: a transparent state (a transparent mode) that allows the incident light to pass though optical device 1 without changing the traveling direction of the incident light; and a light distribution state (a light distribution mode) that allows the incident light to pass through optical device 1 after changing the traveling direction of the incident light (or more specifically, after distributing the incident light). More specifically, when a refractive index difference is small between optical medium 31 and uneven structure 32 (projection 32a) (such as when the refractive index of optical medium 31 is the same as or near the refractive index of uneven structure 32 [projection 32a]), light distribution layer 30 achieves the transparent state. On the other hand, when the refractive index difference is large between optical medium 31 and uneven structure 21 (projection 32a), light distribution layer 30 achieves the light distribution state.

As an example, suppose that the refractive index of projection 32a is 1.5. In this case, when the electric field is not applied (that is, in the case of the transparent state), the refractive index of optical medium 31 can be 1.5. When, on the other hand, the electric field is applied (that is, in the case of the light distribution state), the refractive index of optical medium 31 can be about 1.7.

When the refractive index of projection 32a is 1.5, a liquid crystal containing liquid crystal molecule 31a having a refractive index (ordinary-light refractive index) of 1.5 can be used as a material of optical medium 31. In this case, when first electrode 50 and second electrode 60 are not applied with a voltage, the refractive index of optical medium 31 is 1.5. On the other hand, when first electrode 50 and second electrode 60 are applied with a voltage, the refractive index of optical medium 31 is 1.7. Here, with the refractive index difference (=0.2) between optical medium 31 and projection 32a during the voltage application, the light incident on optical device 1 is totally reflected off the interface between optical medium 31 and uneven structure 32 (i.e., the inclined surface of projection 32a) and the traveling direction of the light can be thus changed. More specifically, optical device 1 can achieve the light distribution state.

It should be noted that optical medium 31 may be applied with the electric field from an alternating-current power source or from a direct-current power source. When the alternating-current power source is used, a voltage waveform may be a sinusoidal waveform or a rectangular waveform.

### [Optical Element]

As shown in FIG. 1 and FIG. 2, optical element 40 is disposed on a surface of second substrate 20 on the side opposite to the side facing first substrate 10. Optical element 40 is in a form of, for example, a sheet and disposed on an entire surface of second substrate 20.

Optical element 40 has an optical property of reducing an amount of at least one of first polarized light and second polarized light that differ in a polarization direction. The polarization directions of first polarized light and second polarized light are perpendicular to each other. For example, first polarized light is an s-polarized light (an s-wave), and second polarized light is a p-polarized light (a p-wave).

In the present embodiment, optical element 40 is a polarization plate and has the optical property of reducing the amount of only one of the s-polarized light and the p-polarized light. For example, optical element 40 functioning as the polarization plate has the optical property of allowing only one of the s-polarized light and the p-polarized light to pass through optical element 40 and not allowing the other one to pass through optical element 40. More specifically, optical element 40 is the polarization plate that has the optical property of reducing the p-polarized light by absorbing only the p-polarized light.

It should be noted that the polarization plate may contain a dichroism pigment, for example. In this case, the amount of light absorbed by the polarization plate can be adjusted by, for example, an amount of the dichroism pigment contained in the polarization plate. Moreover, a black pigment may be used as an absorption material contained in the polarization plate, for example.

### [First Electrode and Second Electrode]

As shown in FIG. 1 and FIG. 2, first electrode 50 and second electrode 60 are formed to be an electrical pair that can apply the electric field to light distribution layer 30. It should be noted that first electrode 50 and second electrode 60 are formed to be the pair not only electrically, but positionally as well. Thus, first electrode 50 and second electrode 60 are disposed to be opposite to each other. To be more specific, first electrode 50 and second electrode 60 are disposed in a manner to sandwich light distribution layer 30.

First electrode 50 and second electrode 60 are light-transmissive and allow the incident light to pass through first electrode 50 and second electrode 60. First electrode 50 and second electrode 60 are, for example, transparent conductive layers. Examples of a material of the transparent conductive layer include the following: a transparent metallic oxide, such as indium tin oxide (ITO) or indium zinc oxide (IZO); a conductor-containing resin that contains an electrical conductor, such as a silver nanowire or a conductive particle; and a metal thin film, such as a silver thin film. Each of first electrode 50 and second electrode 60 may have a single-layer configuration that includes one of the above materials. Alternatively, each of first electrode 50 and second electrode 60 may have a multi-layer configuration that includes the above materials (for example, a multi-layer configuration that includes the transparent metallic oxide and the metal thin film).

First electrode 50 is interposed between first substrate 10 and light distribution layer 30. To be more specific, first electrode 50 is formed on a surface of first substrate 10 on the side closer to light distribution layer 30.

On the other hand, second electrode 60 is disposed between light distribution layer 30 and second substrate 20. To be more specific, second electrode 60 is formed on a surface of second substrate 20 on the side closer to light distribution layer 30.

### [Optical Action of Optical Device]

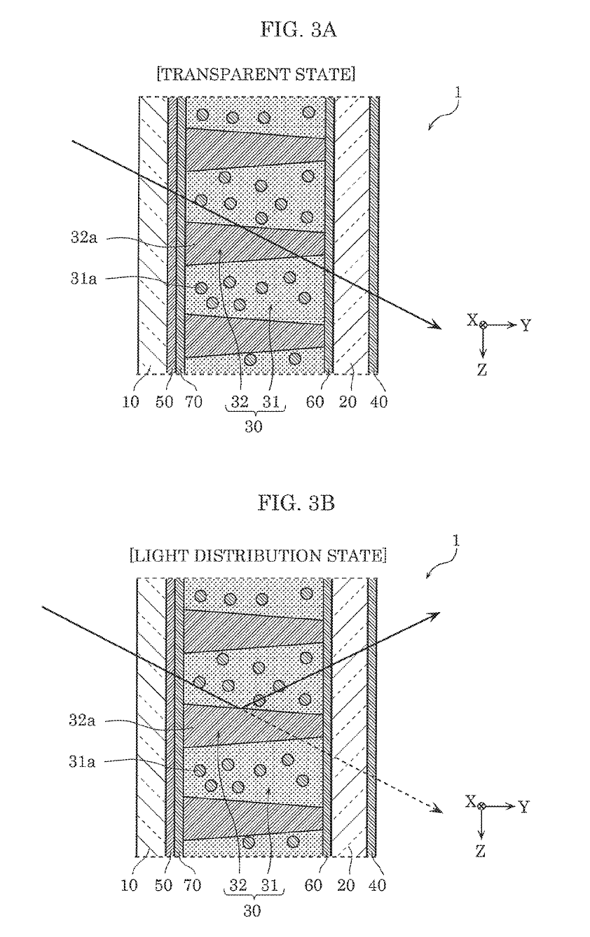

Next, the optical action of optical device 1 according to Embodiment 1 is described, with reference to FIG. 3A and FIG. 3B. FIG. 3A is a diagram for explaining the optical action of optical device 1 in the transparent state, according to Embodiment 1. FIG. 3B is a diagram for explaining the optical action of optical device 1 in the light distribution state, according to Embodiment 1.

Optical device 1 allows light pass through optical device 1. In the present embodiment, first substrate 10 is a substrate disposed on a light-entering side. Thus, optical device 1 allows light entering from first substrate 10 to pass through optical device 1 and thus to be emitted from optical element 40.

The light entering optical device 1 is subjected to the optical action when passing through light distribution layer 30. In this case, the light entering optical device 1 is subjected to the optical action that is different depending on the refractive index of optical medium 31 of light distribution layer 30.

In the present embodiment, the refractive index of projection 32a is 1.5. Moreover, when no voltage is applied to first electrode 50 and second electrode 60, the refractive index of optical medium 31 (liquid crystal) is 1.5. In this case, there is no refractive index difference between projection 32a and optical medium 31. Thus, optical device 1 achieves the transparent state, and the light incident on optical device 1 passes straight through optical device 1 without being totally reflected off the inclined surface of projection 32a as shown in FIG. 3A.

On the other hand, when first electrode 50 and second electrode 60 are applied with the voltage, the refractive index of optical medium 31 (liquid crystal) changes to 1.7. In this case, there is a refractive index difference between projection 32a and optical medium 31. Thus, optical device 1 achieves the light distribution state. Here, as shown in FIG. 3B, the light incident on optical device 1 in an obliquely downward direction and then on an upper inclined surface of projection 32a at a critical angle or larger is totally reflected off the upper inclined surface of projection 32a and thus changed in the traveling direction to pass through optical device 1 in an obliquely upward direction.

### [Usage Example and Function Effect of Optical Device]

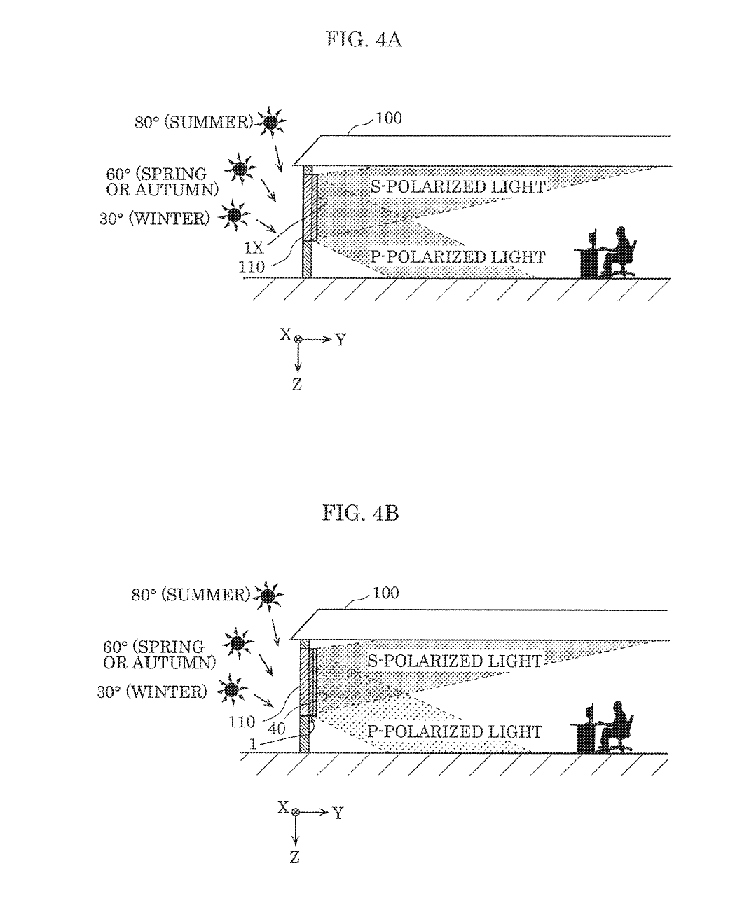

Next, a usage example and function effect of optical device 1 according to Embodiment 1 is described, with reference to FIG. 4A and FIG. 4B. FIG. 4A is a diagram showing an example of using optical device 1X according to a comparative example. FIG. 4B is a diagram showing an example of using optical device 1 according to Embodiment 1.

Optical device 1X according to the comparative example as shown in FIG. 4A is different from optical device 1 according to Embodiment 1 as shown in FIG. 1 in that optical element 40 is not provided. Thus, as in the case of optical device 1 according to Embodiment 1, an optical action of optical device 1X according to the comparative example switches between a transparent state and a light distribution state depending on an application of a voltage to first electrode 50 and second electrode 60.

As shown in FIG. 4A and FIG. 4B, each of optical device 1 and optical device 1X is implemented as a window with a light distribution function when mounted to window 110 of building 100. Each of optical device 1 and optical device 1X is bonded to window 110 via, for example, a sticky layer. In this case, each of optical device 1 and optical device 1X is mounted to window 110 in a posture in which each of the main surfaces of first substrate 10 and second substrate 20 is parallel to the vertical direction (i.e., the Z axis direction) (or more specifically, mounted to window 110 in an upright posture).

Although detailed configurations of optical device 1 and optical device 1X are not illustrated in FIG. 4A and FIG. 4B, each of optical device 1 and optical device 1X is disposed in a manner that first substrate 10 is located outside the room and that second substrate 20 is located inside the room. To be more specific, each of optical device 1 in FIG. 4B and optical device 1X in FIG. 4A is disposed in a manner that first substrate 10 is located on a light-entering side and that second substrate 20 is located on a light-emitting side.

When optical device 1X shown in FIG. 4A is in the light distribution state, outside light, such as sunlight, entering optical device 1X is totally reflected off light distribution layer 30 and guided to the ceiling of the room. More specifically, sunlight entering optical device 1X in an obliquely downward direction from obliquely above optical device 1X is deflected by light distribution layer 30 in a direction in which sunlight bounces back. With this, the ceiling of the room can be illuminated with sunlight as shown in FIG. 4A, and indoor illuminance can be enhanced. Thus, an indoor lighting fixture can be turned off, and an optical output of the indoor lighting fixture can be reduced. This results in electrical power saving.

Suppose that optical device 1X according to the comparative example as shown in FIG. 4A is used and the ceiling surface is illuminated with sunlight through light distribution. Here, optical medium 31 of light distribution layer 30 contains the birefringent liquid crystal molecule. On this account, although the s-polarized light (s-polarized light component) of sunlight can be distributed toward the ceiling surface, the p-polarized light (p-polarized light component) of sunlight cannot be distributed. Thus, even when optical device 1X is in the light distribution state, the p-polarized light passes through optical device 1X and travels in a straight line toward a floor surface. Thus, a person by the window inside the room may be dazzled by bright sunlight.

On the other hand, optical device 1 according to the present embodiment includes the polarization plate as optical element 40. Thus, when the ceiling surface is illuminated with sunlight through light distribution as shown in FIG. 4B, the p-polarized light that is not distributed by optical device 1 is reduced in amount by optical element 40. This can suppress the dazzled feeling of the person by the window inside the room.

In this way, optical device 1 according to the present embodiment can brighten up the room without loss of the primary function of the window that the outside view can be seen (or more specifically, the function of providing transparency and a sense of openness). At the same time, the dazzled feeling of the person by the window inside the room can be suppressed.

Here, optical device 1 according to the present embodiment that was actually manufactured as an implementation example is described.

In this implementation example, a transparent resin substrate formed from PET was used as first substrate 10, and first electrode 50 having a thickness of 100 nm was formed on this resin substrate. On this resin substrate on which first electrode 50 was formed, uneven structure 32 in which a plurality of projections 32a were formed using acrylic resin (having a refractive index of 1.5) at 2-μm intervals was formed by mold embossing. Here, each of the plurality of projections 32a had a height of 10 μm and was in a trapezoidal shape in cross section. In this way, a first transparent substrate was manufactured. Note that the plurality of projections 32a are formed in stripes.

Next, second substrate 20 on which second electrode 60 was formed was used as a second transparent substrate (an opposite substrate). Then, a sealing resin was formed between the first transparent substrate and the second transparent substrate to seal the first transparent substrate and the second transparent substrate. In this sealed state, a positive liquid crystal containing liquid crystal molecule 31a was injected as optical medium 31 between the first transparent substrate and the second transparent substrate, by a vacuum injection method. Here, liquid crystal molecule 31a was in a shape of a rod and had a higher permittivity in a long axis direction and a lower permittivity in a direction perpendicular to the long axis direction.

After this, a polarization plate was affixed as optical element 40 to a surface of second substrate 20 on the side opposite to the side facing second electrode 60. In this way, optical device 1 can be obtained.

It should be noted that liquid crystal molecules 31a are known to be oriented along the shape of uneven structure 32. On this account, an orientation film may be formed on the surface of second electrode 60 and a rubbing treatment may be performed on this film. As a result, liquid crystal molecules 31a can be oriented horizontally with respect to the main surface of second substrate 20 in an entire region of second substrate 20. Here, the liquid crystal had an ordinary-light refractive index of 1.5 and an extraordinary-light refractive index of 1.7.

Since optical device 1 manufactured in this way includes the liquid crystal as optical medium 31, both the light distribution state and the transparent state can be achieved. More specifically, by changing the refractive index of optical medium 31 by the application of the voltage to first electrode 50 and second electrode 60, optical device 1 can switch between the light distribution state and the transparent state. However, note that since the liquid crystal contains the birefringent liquid crystal molecules, the optical transmittance of optical device 1 in the light distribution state is reduced to approximately half. In the transparent state, on the other hand, since both the s-polarized light and the p-polarized light can pass through optical device 1, the optical transmittance is not reduced to half unlike the case of the light distribution state.

Suppose that optical device 1 having such a configuration is mounted to a window and is brought into the light distribution state. In this case, light entering optical device 1 at a solar elevation angle of 30° to 60° is distributed by light distribution layer 30 and then illuminates the ceiling surface of the room.

Here, suppose that light enters optical device 1 at an incident angle of 30°, for example. In this case, 50% of this light is distributed to the ceiling surface at an elevation angle of 15°, and the remaining 50% of the light is not distributed. A part of the incident light is distributed and another part of the incident light is not distributed in this way because the liquid crystal is birefringent. To be more specific, only the s-polarized sunlight contributes to light distribution by light distribution layer 30, and thus the p-polarized sunlight is not distributed by light distribution layer 30. When optical element 40 is not provided as in the case of optical device 1X according to the comparative example shown in FIG. 4A, the whole p-polarized light that is not distributed passes through optical device 1X and travels in a straight line toward the floor surface. On the other hand, since optical device 1 according to the present embodiment includes optical element 40, the p-polarized light that is not distributed is absorbed by optical element 40. As a result, the amount of p-polarized light that travels toward the floor surface is reduced as shown in FIG. 4B.

### CONCLUSION

As described thus far, with optical device 1 according to the present embodiment, light distribution layer 30 that includes optical medium 31 containing the birefringent material and uneven structure 32 is interposed between first substrate 10 and second substrate 20. Moreover, on the surface of second substrate 20 on the side opposite to the side facing first substrate 10, optical element 40 is disposed which has the optical property of reducing the amount of at least one of the first polarized light and the second polarized light that differ in the polarization direction.

Suppose that optical device 1 is in the light distribution state and that one of the first polarized light and the second polarized light in the incident light is distributed and the other is not because of the birefringence of the birefringent material included in optical medium 31. Even in this case, the above configuration allows optical element 40 to reduce the amount of at least one of the first polarized light and the second polarized light. Thus, light distribution control can be performed as desired on the incident light including the first polarized light and the second polarized light that differ in the polarization direction, and the light can illuminate a predetermined area.

In particular, the amount of undistributed incident light is reduced by optical element 40 in the present embodiment. With this, the incident light passing through optical device 1 can be easily controlled, and thus the light can further illuminate the predetermined area.

To be more specific, when optical device 1 is mounted to window 110 and outside light, such as sunlight, is distributed by optical device 1, the amount of p-polarized light can be reduced by optical element 40, as shown in FIG. 4B. With this, even when the outside light is distributed toward the ceiling surface, optical device 1 can brighten up the room without loss of the primary function of the window that the outside view can be seen. At the same time, the dazzled feeling of the person by the window inside the room can be suppressed.

Moreover, optical element 40 according to the present embodiment is the polarization plate having the optical property of reducing the amount of only one of the first polarized light and the second polarized light that differ in the polarization direction.

With this, optical element 40 functioning as the polarization plate can easily reduce the amount of at least one of the first polarized light and the second polarized light. Moreover, the polarization plate can block one of the first polarized light and the second polarized light. For example, in FIG. 4B, the amount of p-polarized light can be reduced by optical element 40. More specifically, the p-polarized light can be blocked. In this case, only the distributed s-polarized light illuminates the ceiling surface, and no light illuminates the floor surface.

Furthermore, first electrode 50 and second electrode 60 disposed in a manner to sandwich light distribution layer 30 are provided, according to the present embodiment. The refractive index of optical medium 31 of light distribution layer 30 changes in response to the application of the voltage to first electrode 50 and second electrode 60.

Thus, by the control of the voltage to be applied to first electrode 50 and second electrode 60, optical device 1 can switch between the transparent state and the light distribution state.

### Variation 1 of Embodiment 1

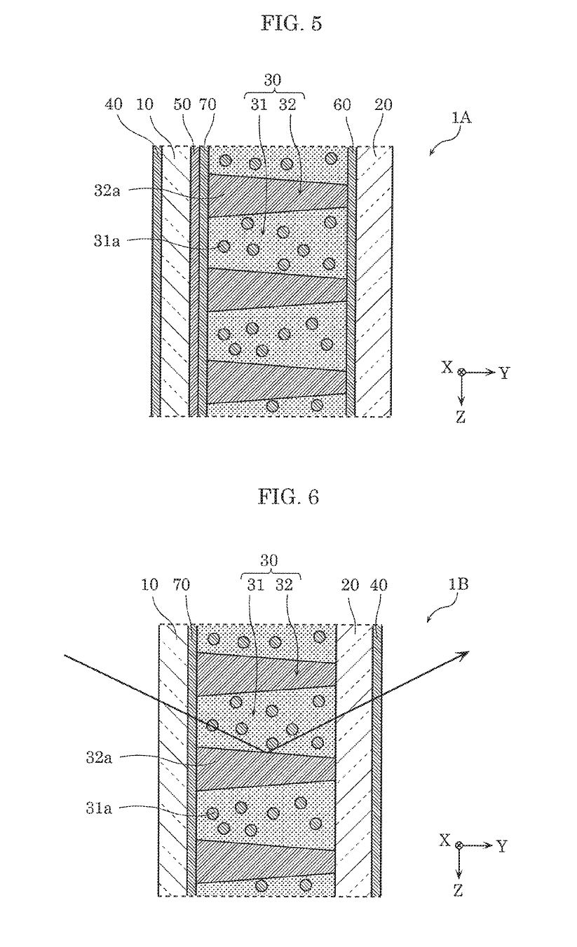

Hereinafter, optical device 1A according to Variation 1 of Embodiment 1 is described, with reference to FIG. 5. FIG. 5 is an enlarged cross-sectional view of optical device 1A according to Variation 1 of Embodiment 1.

Optical device 1 according to Embodiment 1 described above includes optical element 40 that is disposed on second substrate 20. On the other hand, optical element 40 according to the present variation is disposed on first substrate 10 as shown in FIG. 5. To be more specific, optical element 40 is disposed on a surface of first substrate 10 on the side opposite to the side facing second substrate 20.

With optical device 1A according to the present variation described above, the same advantageous effect as in the case of optical device 1 according to Embodiment 1 can also be achieved.

As described thus far, optical element 40 may be disposed on the surface of second substrate 20 on the side opposite to the side facing first substrate 10 as in Embodiment 1, or disposed on the surface of first substrate 10 on the side opposite to the side facing second substrate 20.

It should be noted that the present variation can also be applied to Embodiments 2 and 3 described below.

### Variation 2 of Embodiment 1

Hereinafter, optical device 1B according to Variation 2 of Embodiment 1 is described, with reference to FIG. 6. FIG. 6 is an enlarged cross-sectional view of optical device 1B according to Variation 2 of Embodiment 1.

Optical device 1 according to Embodiment 1 described above includes first electrode 50 and second electrode 60. On the other hand, first electrode 50 and second electrode 60 are not provided in the present variation, as shown in FIG. 6. This means that light distribution layer 30 is not applied with an electric field in the present variation. Therefore, the orientation state of liquid crystal molecules 31a of optical medium 31 (liquid crystal) does not change, and thus the refractive index of optical medium 31 does not change.

For this reason, materials of uneven structure 32 (projection 32a) and optical medium 31 (liquid crystal) are selected so that the refractive index of uneven structure 32 (projection 32a) is always different from the refractive index of optical medium 31 (liquid crystal).

With this, optical device 1B according to the present variation is always in the light distribution state. In other words, light entering optical device 1B is always changed in the traveling direction and then passes through optical device 1B.

In the case of optical device 1B according to the present variation described above, optical medium 31 of light distribution layer 30 also includes a birefringent material. To be more specific, optical medium 31 includes a liquid crystal as the birefringent material.

With this configuration, one of the first polarized light and the second polarized light of the incident light passes through optical device 1B by the birefringence of the birefringent material included in optical medium 31. However, the amount of one of the first polarized light and the second polarized light is reduced by optical element 40. Thus, also in the present variation, light distribution control can be performed as desired on the incident light including the first polarized light and the second polarized light that differ in a polarization direction, and the light can illuminate a predetermined area.

It should be noted that the present variation can also be applied to Embodiments 2 and 3 described below.

### Variation 3 of Embodiment 1

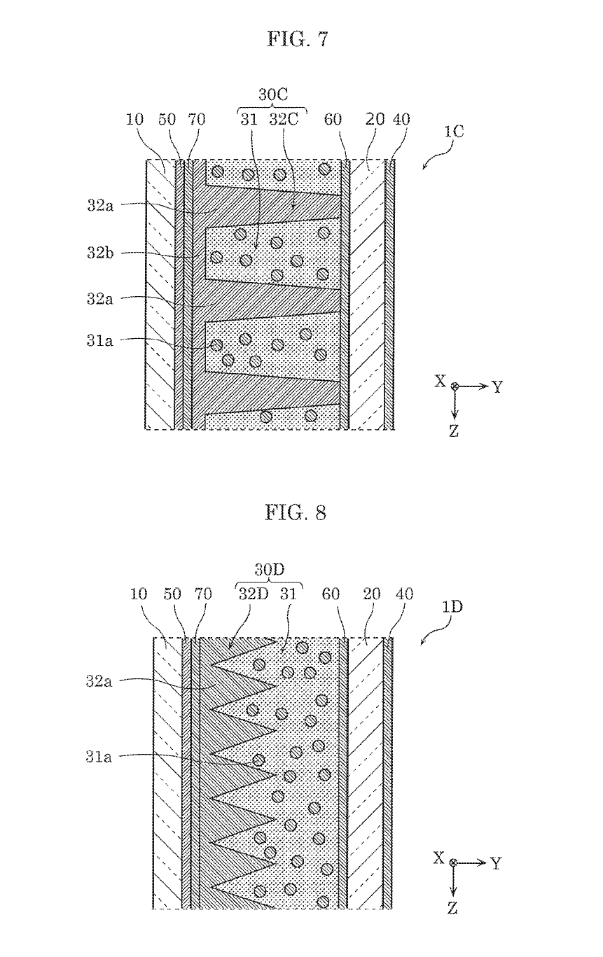

Hereinafter, optical device 1C according to Variation 3 of Embodiment 1 is described, with reference to FIG. 7. FIG. 7 is an enlarged cross-sectional view of optical device 1C according to Variation 3 of Embodiment 1.

In the case of optical device 1 according to Embodiment 1 described above, the plurality of projections 32a included in uneven structure 32 of light distribution layer 30 are formed separately from each other. On the other hand, in the case of optical device 1C according to the present variation, a plurality of projections 32a included in uneven structure 32C of light distribution layer 30C may be connected to each other as shown in FIG. 7.

To be more specific, uneven structure 32C includes the following: thin film layer 32b that is formed on the side closer to first substrate 10 (the side closer to adhesion layer 70); and the plurality of projections 32a that project from thin film layer 32b. Thin film layer 32b may be formed by design or as a residual film formed when the plurality of projections 32a are formed. In this case, thin film layer 32b (the residual film) may have a thickness of 1 μm or less, for example.

With optical device 1C according to the present variation described above, the same advantageous effect as in the case of optical device 1 according to Embodiment 1 can also be achieved.

It should be noted that the present variation can also be applied to Embodiments 2 and 3 described below.

### Variation 4 of Embodiment 1

Hereinafter, optical device 1D according to Variation 4 of Embodiment 1 is described, with reference to FIG. 8. FIG. 8 is an enlarged cross-sectional view of optical device 1D according to Variation 4 of Embodiment 1.

In the case of optical device 1 according to Embodiment 1 described above, each of the plurality of projections 32a included in uneven structure 32 of light distribution layer 30 is nearly trapezoidal in cross section and has nearly the shape of the elongated quadratic prism. On the other hand, in the case of optical device 1D according to the present variation, each of the plurality of projections 32a included in uneven structure 32D of light distribution layer 30D is nearly triangular in cross section and has nearly a shape of an elongated triangular prism.

In this case, each of the plurality of projections 32a has a height of 100 nm to 100 μm in the cross-sectional shape (in the triangular shape) and an aspect (height to base) ratio is about 1 to 5. A pitch between projections 32a adjacent to each other is, for example, 100 nm to 100 μm.

It should be noted that the height and the aspect ratio of projection 32a are not limited to the aforementioned ranges. Moreover, the cross-sectional shape of projection 32a is not limited to a triangle or a trapezoid.

With optical device 1D according to the present variation described above, the same advantageous effect as in the case of optical device 1 according to Embodiment 1 can also be achieved.

It should be noted that the present variation can also be applied to Embodiments 2 and 3 described below.

### Embodiment 2

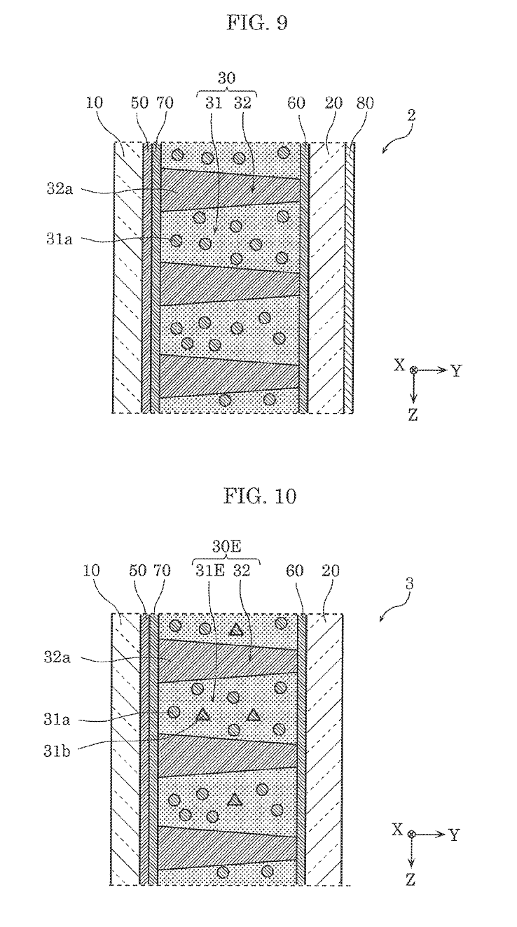

Hereinafter, optical device 2 according to Embodiment 2 is described, with reference to FIG. 9. FIG. 9 is an enlarged cross-sectional view of optical device 2 according to Embodiment 2.

The present embodiment includes optical element 80 shown in FIG. 9 which has an optical property of reducing an amount of at least one of first polarized light and second polarized light that differ in a polarization direction as in the case of Embodiment 1. Optical element 80 is disposed on a surface of second substrate 20 on the side opposite to the side facing first substrate 10. To be more specific, optical element 80 is in a form of, for example, a sheet and disposed on an entire surface of second substrate 20.

Optical device 2 according to the present embodiment is different from optical device 1 according to Embodiment 1 described above in that, although optical device 1 according to Embodiment 1 includes the polarization plate as optical element 40, optical device 2 according to the present embodiment includes a dimming plate as optical element 80. Optical element 80 functioning as the dimming plate has an optical property that a transmittance is lower when the amount of incident light is larger and that the transmittance is higher when the amount of incident light is smaller. The dimming plate may be formed using glass or resin. Moreover, the dimming plate may reversibly change in color depending on light.

As described thus far, optical device 2 according to the present embodiment includes optical element 80 having the optical property of reducing the amount of at least one of the first polarized light and the second polarized light that differ in the polarization direction, as with optical element 40 according to Embodiment 1.

Suppose that optical device 2 is in the light distribution state and that one of the first polarized light and the second polarized light in the incident light is distributed and the other is not because of the birefringence of the birefringent material included in optical medium 31. Even in this case, the above configuration allows optical element 80 to reduce the amount of at least one of the first polarized light and the second polarized light, as in the case of Embodiment 1. Thus, light distribution control can be performed as desired on the incident light including the first polarized light and the second polarized light that differ in the polarization direction, and the light can illuminate a predetermined area.

Moreover, when optical device 2 is mounted to a window and outside light, such as sunlight, is distributed by optical device 2, the amount of p-polarized light can be reduced by optical element 80, as in the case of Embodiment 1. With this, even when the outside light is distributed toward the ceiling surface, optical device 2 can brighten up the room without loss of the primary function of the window that the outside view can be seen. At the same time, the dazzled feeling of the person by the window inside the room can be suppressed.

Furthermore, optical element 80 according to the present embodiment is the dimming plate having the optical property that the transmittance is lower when the amount of incident light is larger and that the transmittance is higher when the amount of incident light is smaller.

With this, optical element 80 functioning as the dimming plate can easily reduce the amount of at least one of the first polarized light and the second polarized light. For example, when optical device 2 is mounted to a window, optical element 80 (the dimming plate) can reduce the amount of p-polarized light that is not distributed.

Note, however, that since the dimming plate is included as optical element 80 according to the present embodiment, the amount of the distributed p-polarized light is also reduced. On this account, optical device 2 which includes the dimming plate has characteristics of significantly reducing the p-polarized light when the sunshine is strong and hardly reducing the p-polarized light when the sunshine is weak, as compared with optical device 1 which includes the polarization plate. More specifically, the amount of the reduced p-polarized light is large under the strong sunshine, and the amount of the reduced p-polarized light is small under the weak sunshine. Thus, optical device 2 which includes the dimming plate does not reduce the p-polarized light unnecessarily.

### Embodiment 3

Hereinafter, optical device 3 according to Embodiment 3 is described, with reference to FIG. 10. FIG. 10 is an enlarged cross-sectional view of optical device 3 according to Embodiment 3.

With optical device 1 according to Embodiment 1 described above, optical element 40 reduces the amount of at least one of the first polarized light and the second polarized light that differ in the polarization direction. On the other hand, with optical device 3 according to the present embodiment, light distribution layer 30E shown in FIG. 10 reduces an amount of at least one of first polarized light and second polarized light that differ in a polarization direction. Thus, optical device 3 according to the present embodiment does not include optical element 40 or optical element 80.

Light distribution layer 30E according to the present embodiment includes optical medium 31E and uneven structure 32. Optical medium 31E includes the following: liquid crystal molecule 31a that is birefringent; and dichroic liquid crystal molecule 31b that has an optical property of reducing the amount of at least one of the first polarized light and the second polarized light that differ in the polarization direction.

Generally speaking, liquid crystal containing dichroic liquid crystal molecules (i.e., dichroic liquid crystal) can add a color to certain polarized light. For example, when black dichroic liquid crystal is used, certain polarized light can be absorbed and the amount of light that passes through the optical device can be thus reduced. In the present embodiment, dichroic liquid crystal molecule 31b has an optical property of reducing the amount of p-polarized light by absorbing only the p-polarized light, out of the s-polarized light and the p-polarized light for example. Although dichroic liquid crystal molecule 31b is, for example, black, the color is not limited to black. When optical medium 31E contains dichroic liquid crystal molecule 31b that is black, the whole of optical device 3 looks dark and the light transmittance in the transparent state decreases. However, the amount of p-polarized light in the light distribution state can be reduced.

As described thus far, optical device 3 according to the present embodiment includes light distribution layer 30E which has optical medium 31E and uneven structure 32. Optical medium 31E includes the following: liquid crystal molecule 31a that is birefringent; and dichroic liquid crystal molecule 31b that has the optical property of reducing the amount of at least one of the first polarized light and the second polarized light that differ in the polarization direction.

Suppose that optical device 3 is in the light distribution state and that one of the first polarized light and the second polarized light in the incident light is distributed and the other is not because of the birefringence of liquid crystal molecules 31a contained in optical medium 31E. Even in this case, dichroic liquid crystal molecules 31b contained in optical medium 31E can reduce the amount of at least one of the first polarized light and the second polarized light. Thus, even when the incident light is distributed, the emitted light can illuminate a predetermined area as in Embodiments 1 and 2.

In addition, optical element 40 or 80 described in Embodiment 1 is not needed according to the present embodiment. Thus, optical device 3 can be manufactured at low cost as compared with Embodiments 1 and 2.

Moreover, dichroic liquid crystal molecule 31b according to the present embodiment has the optical property of reducing the amount of p-polarized light by absorbing only the p-polarized light, out of the s-polarized light and the p-polarized light. Thus, when optical device 3 is mounted to a window and outside light, such as sunlight, is distributed by optical device 3, the amount of p-polarized light that is not distributed can be reduced by dichroic liquid crystal molecule 31b. With this, even when the outside light is distributed toward the ceiling surface, optical device 3 can brighten up the room without loss of the primary function of the window that the outside view can be seen. At the same time, the dazzled feeling of the person by the window inside the room can be suppressed.

In the present embodiment, dichroic liquid crystal molecule 31b is used. However, it should be noted that, instead of dichroic liquid crystal molecule 31b, a dichroic pigment having an optical property of reducing the amount of at least one of the first polarized light and the second polarized light that differ in the polarization direction may be used. To be more specific, optical medium 31E may include liquid crystal molecule 31a that is birefringent and a dichroic pigment.

Here, optical device 3 according to the present embodiment that was actually manufactured as an implementation example is described.

In this implementation example, a transparent resin substrate formed from PET was used as first substrate 10, and first electrode 50 having a thickness of 100 nm was formed on this resin substrate. On this resin substrate on which first electrode 50 was formed, uneven structure 32 in which a plurality of projections 32a were formed using acrylic resin (having a refractive index of 1.5) at 2-μm intervals was formed by mold embossing. Here, each of the plurality of projections 32a had a height of 10 μm and was in a trapezoidal shape in cross section. In this way, a first transparent substrate was manufactured. Note that the plurality of projections 32a are formed in stripes.

Next, second substrate 20 on which second electrode 60 was formed was used as a second transparent substrate (an opposite substrate). Then, a sealing resin was formed between the first transparent substrate and the second transparent substrate to seal the first transparent substrate and the second transparent substrate. In this sealed state, a positive liquid crystal containing liquid crystal molecule 31a and a liquid crystal containing dichroic liquid crystal molecule 31b (a dichroic liquid crystal) were injected as optical medium 31 between the first transparent substrate and the second transparent substrate, by a vacuum injection method. Here, liquid crystal molecule 31a was in a shape of a rod and had a higher permittivity in a long axis direction and a lower permittivity in a direction perpendicular to the long axis direction. In this way, optical device 3 can be obtained.

Here, an orientation film may be formed on the surface of second electrode 60 and a rubbing treatment may be performed on this film in the present embodiment as well. As a result, liquid crystal molecules can be oriented horizontally with respect to the main surface of second substrate 20 in an entire region of second substrate 20. Here, the liquid crystal had an ordinary-light refractive index of 1.5 and an extraordinary-light refractive index of 1.7.

Since optical device 3 manufactured in this way includes the liquid crystal as optical medium 31E, both the light distribution state and the transparent state can be achieved as in the case of optical device 1 according to Embodiment 1. However, note that the optical transmittance of optical device 3 is reduced to approximately half, as in Embodiment 1.

Suppose that optical device 3 having such a configuration is mounted to a window and is brought into the light distribution state. In this case, light entering optical device 3 at a solar elevation angle of 30° to 60° is distributed by light distribution layer 30E and then illuminates the ceiling surface of the room.

Here, suppose that light enters optical device 3 at an incident angle of 30°. In this case, 50% of this light is distributed to the ceiling surface at an elevation angle of 15°, and the remaining 50% of the light is not distributed. To be more specific, although the s-polarized sunlight is distributed by light distribution layer 30, the p-polarized sunlight is not distributed by light distribution layer 30. When optical medium 31E does not include dichroic liquid crystal molecule 31b, the p-polarized light that is not distributed passes through optical device 3 and travels in a straight line toward the floor surface. On the other hand, since optical medium 31E of optical device 3 according to the present embodiment includes dichroic liquid crystal molecule 31b, the p-polarized light that is not distributed is absorbed by dichroic liquid crystal molecule 31b. As a result, the amount of p-polarized light that travels toward the floor surface is reduced.

### Other Variations, Etc.

Although the optical device according to the present invention has been described based on the embodiments and variations, the present invention is not limited to the embodiments and variations described above.

For example, the optical device is mounted to the window in a manner that the longitudinal direction of projection 32a is aligned with the X axis direction, according to the embodiments and variations described above. However, the manner of mounting the optical device is not limited to this. For example, the optical device may be mounted to the window in a manner that the longitudinal direction of projection 32a is aligned with the Z axis direction. In this case, the incident light can be distributed in the horizontal direction instead of the vertical direction as in the embodiments and variations described above. As a result, light distribution control can be performed as desired on the incident light including the first polarized light and the second polarized light that differ in the polarization direction, and the light can illuminate a predetermined area.

Moreover, each of the plurality of projections 32a included in uneven structure 32 has the elongated shape according to the embodiments and variations described above. However, the shape of projection 32a is not limited to this. As an example, the plurality of projections 32a may be arranged to be scattered in a matrix-like manner. More specifically, the plurality of projections 32a may be arranged in a dotted manner.

Furthermore, the plurality of projections 32a have the same shape according to the embodiments and variations described above. However, the shapes of the plurality of projections 32a are not limited to this. For example, the plurality of projections 32a may have different shapes in a plane. For instance, inclination angles of the plurality of projections 32a may differ between an upper half and a lower half of optical device 1 in the Z axis direction. With this, the light may be distributed at an elevation angle of 15° in an upper part of the window and at an elevation angle of 30° in a lower part of the window, for example.

Moreover, the plurality of projections 32a have the same height according to the embodiments and variations described above. However, the heights of the plurality of projections 32a are not limited to this. For example, the plurality of projections 32a may have randomly different heights. This can suppress a state in which the light passing through the optical device becomes iridescent. To be more specific, since the plurality of projections 32a are randomly different in height, minute diffracted or scattering light rays on an uneven interface are averaged over wavelengths and thus coloring of the emitted light is suppressed.

Furthermore, in the embodiments and variations described above, the material used for the optical medium of the light distribution layer may contain, in addition to the liquid crystal material, a high molecule having, for example, a polymer structure. The polymer structure is, for example, a network structure. Liquid crystal molecules are disposed into the polymer structure (meshes of the network). With this, the refractive index becomes adjustable. Examples of the liquid crystal material containing high molecules include polymer dispersed liquid crystal (PDLC) and polymer network liquid crystal (PNLC).

Moreover, although sunlight is described as an example of the light entering the optical device according to the embodiments and variations described above, the light entering the optical device is not limited to sunlight. For example, the light entering the optical device may be light that is emitted by a light-emitting device, such as an illuminating device.

Furthermore, although optical device 1 is affixed to the surface of window 110 on the indoor side according to the embodiments and variations described above, optical device 1 may be affixed to the surface of window 110 on the outdoor side. However, in order to suppress deterioration of the optical element, it is preferable for optical device 1 to be affixed to the surface of window 110 on the indoor side. Moreover, although the optical device is affixed to the window, the optical device itself may be used as the window of building 100. In addition, an installation position of the optical device is not limited to a window of a building, and may be a car window, for example.

It should be noted that other embodiments implemented through various changes and modifications conceived by a person of ordinary skill in the art based on the above embodiments and variations or through a combination of the structural components and functions in the above embodiments and variations unless such combination departs from the scope of the present invention may be included in the scope in an aspect or aspects according to the present invention.

### REFERENCE MARKS IN THE DRAWINGS

1, 1A, 1B, 1C, 1D, 1X, 2, 3 optical device
10 first substrate
20 second substrate
30, 30C, 30D, 30E light distribution layer
31, 31E optical medium
31a liquid crystal molecule
31b dichroic liquid crystal molecule
32, 32C, 32D uneven structure
40, 80 optical element
50 first electrode
60 second electrode
110 window

1. An optical device comprising:
a first substrate which is light-transmissive;
a second substrate which is light-transmissive and opposes the first substrate;
a light distribution layer which is interposed between the first substrate and the second substrate and distributes incident light; and
an optical element which is disposed on one of (i) a surface of the second substrate on a side opposite to a side-facing the first substrate and (ii) a surface of the first substrate on a side opposite to a side facing the second substrate,
wherein the light distribution layer includes (i) an optical medium containing a birefringent material and (ii) an uneven structure, and
the optical element has an optical property of reducing an amount of at least one of first polarized light and second polarized light that differ in a polarization direction.

2. The optical device according to claim 1,
wherein the optical element is a polarization plate which has an optical property of reducing the amount of only one of the first polarized light and the second polarized light.

3. The optical device according to claim 1,
wherein the optical element is a dimming plate which has an optical property that a transmittance is lower when an amount of incident light is larger and that the transmittance is higher when the amount of incident light is smaller.

4. An optical device comprising:
a first substrate which is light-transmissive;
a second substrate which is light-transmissive and opposes the first substrate; and
a light distribution layer which is interposed between the first substrate and the second substrate and distributes incident light,
wherein the light distribution layer includes an optical medium and an uneven structure, and
the optical medium includes (i) a liquid crystal molecule that is birefringent and (ii) one of a dichroic liquid crystal molecule and a dichroic pigment that have an optical property of reducing an amount of at least one of first polarized light and second polarized light that differ in a polarization direction.

5. The optical device according to claim 1, further comprising:
a first electrode and a second electrode which are disposed in a manner to sandwich the light distribution layer,
wherein a refractive index of the optical medium changes in response to an application of a voltage to the first electrode and the second electrode.

6. The optical device according to claim 1,
wherein the birefringent material is a liquid crystal.

7. The optical device according to claim 1,
wherein one of the first polarized light and the second polarized light is p-polarized light, and
an other one of the first polarized light and the second polarized light is s-polarized light.

8. A window with a light distribution function, comprising:
the optical device according to claim 1; and
a window to which the optical device is affixed.
